(19) United States
(12) Patent Application Publication
(10) Pub. No.: US 2004/0054738 A1
(43) Pub. Date: Mar. 18, 2004

(54) Multimedia messaging system and method

(76) Inventors: Chi Chung Su, Tu-Chen (TW); Weihua Guan, Shenzhen (CN); XiangHua Ji, Shenzhen (CN); Shuangjian He, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,299

(22) Filed: Dec. 30, 2002

(30) Foreign Application Priority Data
Sep. 17, 2002 (TW) 91121184

(51) Int. Cl. G06F 15/16; H04M 1/64

(52) U.S. Cl. 709/206; 379/88.12

(57) ABSTRACT

A multimedia messaging system includes a database (61) for storing relevant basic data, a message receiving module (62) for receiving first messages provided by a plurality of message providers (2), a message processing module (66) for generating respective second messages based on the first messages, and a message sending module (68) for transmitting the second messages to respective message receivers (4) or substitutes thereof. Said basic data include message classification data, data on substitutes of message receivers, contact data on message receivers and substitutes thereof, and data on modes of transmission of messages. The message processing module includes a message processing sub-module (661), a feedback receiving sub-module (665), a time controlling sub-module (662), and a conversion controlling sub-module (663). A related multimedia messaging method is also disclosed.

### BACKGROUND OF THE INVENTION

1. Field of the Invention

The present invention relates to multimedia messaging systems and methods, and particularly to a system and method for transmitting messages to substitutes of message receivers if the message receivers themselves do not timely receive the messages.

2. Background of the Invention

Nowadays, many communication means are available for people to contact each other quickly and conveniently. Such means include short message service (SMS), E-mail, and so on. Communications technology has greatly changed the way of life of many people. In May 2001, the GSM (Global System for Mobile communications) Association reported that over 500 billion short messages were sent by way of the GSM system in the first quarter of 2001. More and more message service providers are providing facilities such as financial information, stock information, news, and entertainment information. With the development of communications technology and business applications thereof, message services are required to be reliable and timely. For instance, when a client receives a message, he/she should send return information to a message provider confirming receipt. The client may not timely receive a message because of network congestion, shutdown of equipment, or failure of part of the network. One solution for this problem is to send the messages by way of alternative means. For example, U.S. Pat. No. 5,995,594 issued on Nov. 30th, 1999 discloses a system and method for messaging notification in a multimedia messaging system. For example, when a message provider sends an E-mail to a mail box of a client, the message provider also sends a notification by way of alternative means to the client. The notification informs the client that the E-mail has been sent out. The notification is continually sent until the client sends confirmation of receipt of the E-mail to the message provider.

Although the above-described system and method can transmit messages to a client and ensure that the client eventually receives the messages, there is still no assurance that the client can timely receive the messages. A system and method is needed for promptly transmitting messages and ensuring that recipients or representatives thereof can timely receive the messages.

### SUMMARY OF THE INVENTION

Accordingly, an object of the present invention is to provide a multimedia messaging system and method for transmitting messages from message providers to message receivers in a timely manner.

Another object of the present invention is to provide a multimedia messaging system and method for transmitting messages to representatives of message receivers if the message receivers themselves do not timely receive the messages.

In order to accomplish the above-mentioned objects, the present invention provides a multimedia messaging system and method. A preferred embodiment of the system comprises a database for storing relevant basic data, a message receiving module for receiving first messages provided by a plurality of message providers, a message processing module for generating second messages based on the first messages, and a message sending module for transmitting the second messages to respective message receivers or substitutes thereof. Said basic data include message classification data, data on substitutes of message receivers, contact data on message receivers and substitutes thereof, and data on modes of transmission of messages. The message processing module comprises a message processing sub-module for generating second messages according to respective first messages, a feedback receiving sub-module for receiving return information on second messages, a time controlling sub-module for monitoring whether respective waiting times for receiving return information exceed respective predetermined time limits; and a conversion controlling sub-module for determining whether to transmit second messages to respective substitutes of the message receivers based on the monitoring by the time controlling sub-module.

A preferred embodiment of the multimedia messaging method comprises the following steps: (i) receiving a first message from a message provider, and caching the first message in a first message cache; (ii) generating a second message based on the first message and on contact data on a message receiver, and caching the second message in a second message cache; (iii) transmitting the second message to the message receiver; (iv) determining whether the message receiver sends back return information on the second message within a predetermined time limit; (v) recording feedback time of the second message if the message receiver sends back return information on the second message within the predetermined time limit; (vi) determining whether the message receiver has a substitute receiver if the message receiver does not send back return information on the second message within the predetermined time limit; and (vii) if the message receiver has a substitute receiver, generating a new second message based on contact data on the substitute receiver, adding a new message process record, and returning to step (iii); or (viii) recording no feedback if the message receiver does not have a substitute receiver.

### BRIEF DESCRIPTION OF THE DRAWINGS

Other objects, advantages and novel features of the present invention will be drawn from the following detailed description of preferred embodiments of the present invention with the attached drawings, in which:

FIG. 1 is a schematic diagram of an application environment of a multimedia messaging system in accordance with a preferred embodiment of the present invention, said application environment including message providers and message receivers;

FIG. 2 is a schematic diagram of infrastructure of the multimedia messaging system of the present invention, together with said message providers and message receivers;

FIG. 3 is a schematic diagram of infrastructure of a basic data setting module of the multimedia messaging system of the present invention;

FIG. 4A illustrates an exemplary message classification sheet in accordance with the present invention;

FIG. 4B illustrates an exemplary substitute message receiver sheet in accordance with the present invention;

FIG. 4C illustrates an exemplary contact data sheet in accordance with the present invention;

FIG. 4D illustrates an exemplary process recording sheet in accordance with the present invention;

FIG. 5 is a schematic diagram of infrastructure of a message processing module of the multimedia messaging system of the present invention; and

FIG. 6 is a flow chart of operation of the multimedia messaging system of the present invention in said application environment, in accordance with a preferred embodiment of the present invention.

### DETAILED DESCRIPTION OF PREFERRED EMBODIMENTS OF THE INVENTION

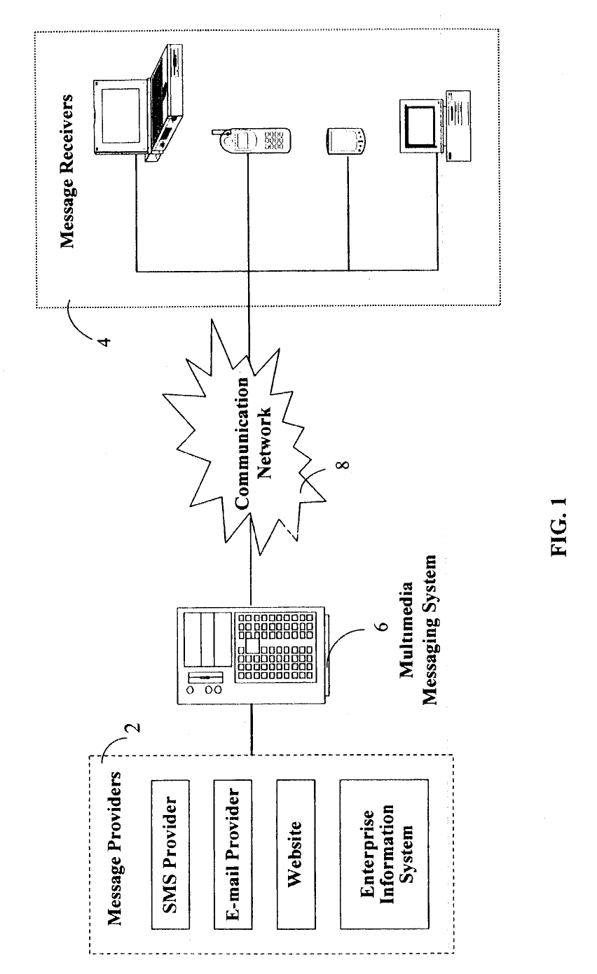

FIG. 1 is a schematic diagram of an application environment of a multimedia messaging system 6 in accordance with a preferred embodiment of the present invention. The multimedia messaging system 6 is linked to a plurality of message providers 2 for receiving various first messages. The multimedia messaging system 6 processes received first messages and generates corresponding second messages. The second messages comprise the received first messages. By means of a communication network 8, the multimedia messaging system 6 transmits various generated second messages to corresponding message receivers 4. The message providers 2 may for example be any one or more of a short message service (SMS) provider, an E-mail service provider, a website, and an enterprise information system (EIS). Once registered in the multimedia messaging system 6, each message provider 2 can provide various first messages for the multimedia messaging system 6. The clients 4 may for example be any one or more of a personal computer, a mobile phone, a personal digital assistant, and a laptop computer. The communication network 8 may or may not be a wireless network.

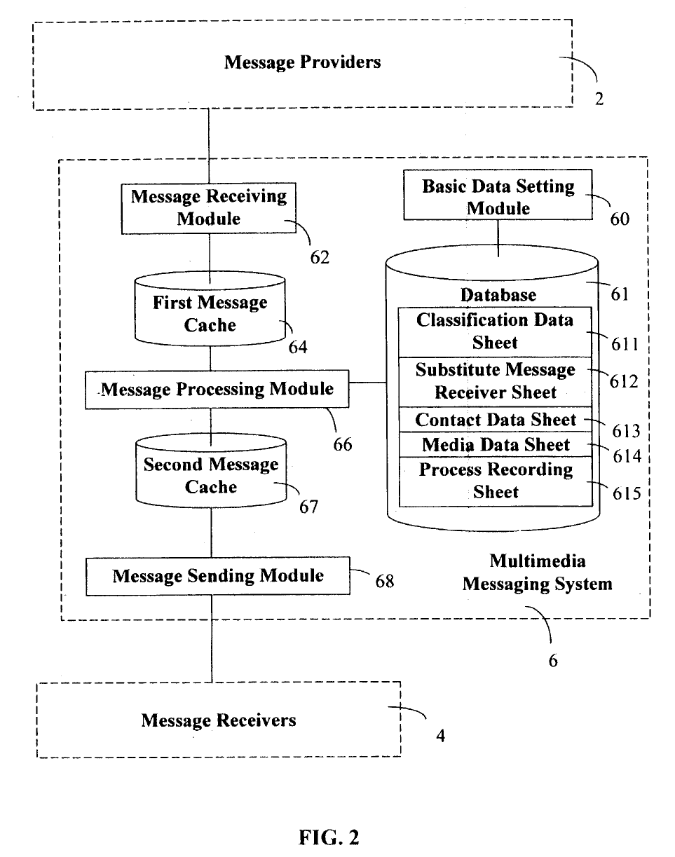

FIG. 2 is a schematic diagram of infrastructure of the multimedia messaging system 6, together with the message providers 2 and message receivers 4. The multimedia messaging system 6 comprises a basic data setting module 60, a database 61, a message receiving module 62, a first message cache 64, a message processing module 66, a second message cache 67, and a message sending module 68. The basic data setting module 60 is used for setting relevant basic data, which includes message classification data, data on substitutes of message receivers, contact data on message receivers and substitutes thereof, and data on modes of transmission of messages. The basic data are stored in various sheets in the database 61. The sheets include a classification data sheet 611, a substitute message receiver sheet 612, a contact data sheet 613, a media data sheet 614, and a process recording sheet 615.

The message receiving module 62 receives first messages from the message providers 2, and stores the received first messages in the first message cache 64. Each first message comprises a message classification, a message receiver, and message content. Message classifications may for example include inbound notices and outbound notices. The message processing module 66 accesses the first message cache 64 to obtain the first messages, and generates corresponding second messages. Each second message comprises a mode of transmission, a name of the message receiver, an address of the message receiver, and the first message content. Second messages generated by the message processing module 66 are stored in the second message cache 67. The message sending module 68 retrieves second messages from the second message cache 67, and transmits retrieved second messages to relevant message receivers 4.

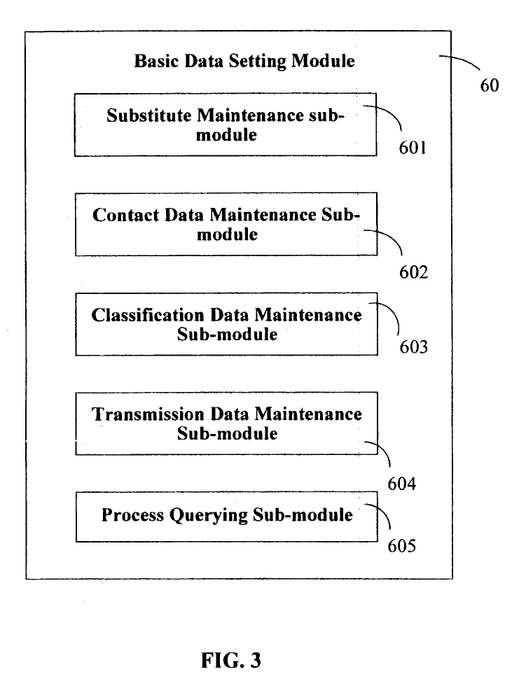

FIG. 3 is a schematic diagram of infrastructure of the basic data setting module 60. The basic data setting module 60 comprises a substitute maintenance sub-module 601, a contact data maintenance sub-module 602, a classification data maintenance sub-module 603, a transmission data maintenance sub-module 604, and a process querying sub-module 605. The substitute maintenance sub-module 601 is used for adding, modifying, and deleting data on substitutes of message receivers. The contact data maintenance sub-module 602 is used for adding, modifying, deleting, and querying contact data on message receivers and substitutes thereof. The classification data maintenance sub-module 603 is used for adding, modifying, deleting, and querying data on message classifications. The transmission data maintenance sub-module 604 is used for adding, modifying, deleting, and querying data on modes of transmission. The process querying sub-module 605 is used for querying data on procedures for processing messages.

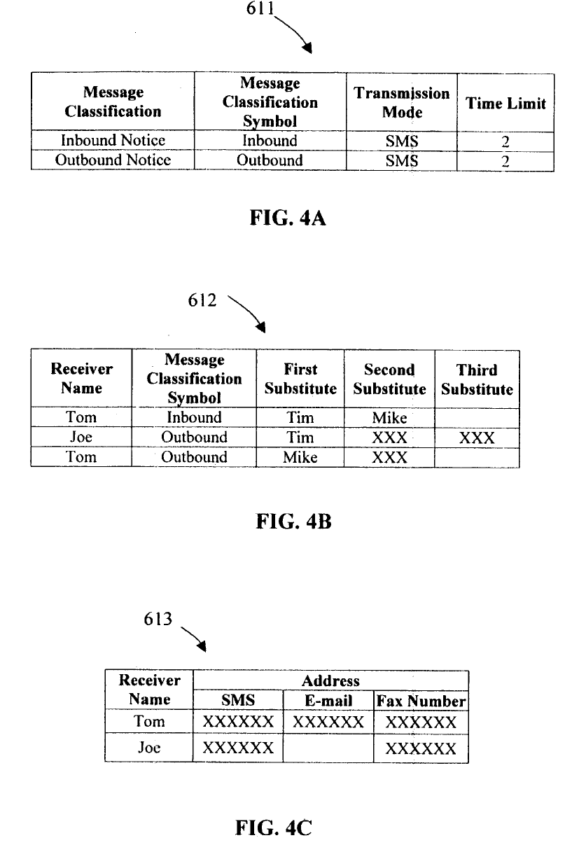

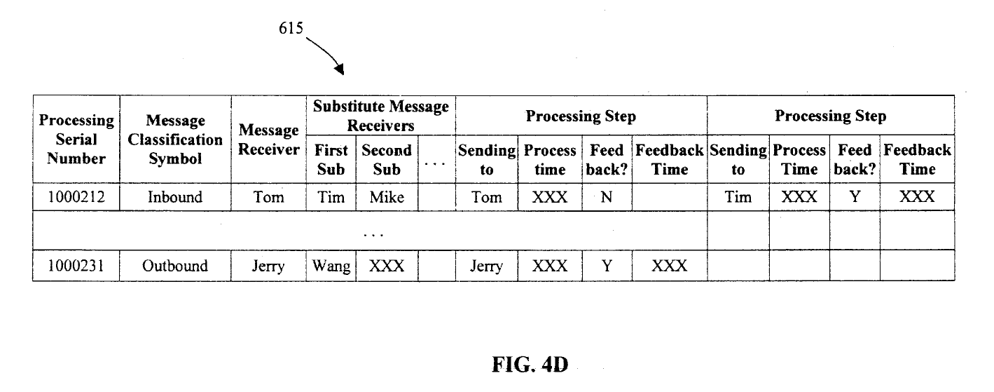

FIG. 4A illustrates an exemplary message classification sheet 611 in accordance with the present invention. The message classification sheet. 611 comprises the following columns: message classification, message classification symbol, transmission mode, and time limit. If no return information is sent back by a message receiver 4 within a time limit of a message, it is assumed that the message is not received by the message receiver 4.

FIG. 4B illustrates an exemplary substitute message receiver sheet 612 in accordance with the present invention. The substitute message receiver sheet 612 is used for recording substitutes of message receivers, and comprises the following columns: receiver name, message classification symbol, first substitute, second substitute, and third substitute. If a message receiver does not timely receive a second message, the multimedia messaging system 6 transmits the second message to a substitute of the message receiver.

FIG. 4C illustrates an exemplary contact data sheet 613 in accordance with the present invention. The contact data sheet 613 comprises the following columns: receiver name, and address. The address column comprises the following sub-columns: SMS, E-mail, and fax number.

FIG. 4D illustrates an exemplary process recording sheet 615 in accordance with the present invention. The process recording sheet 615 comprises a variety of message processing records. Each message processing record comprises a processing serial number, a message classification symbol, a message receiver, a substitute message receiver, and a plurality of processing steps.

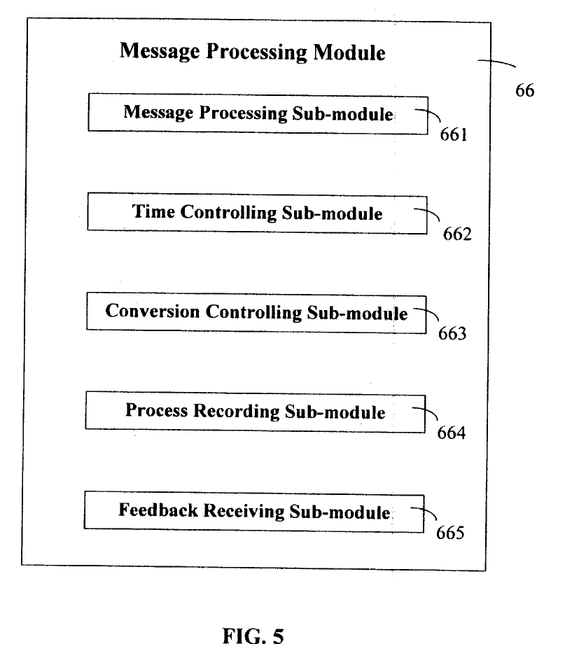

FIG. 5 is a schematic diagram of infrastructure of the message processing module 66. In the preferred embodiment of the present invention, the message processing module 66 comprises a message processing sub-module 661, a time controlling sub-module 662, a conversion controlling sub-module 663, a process recording sub-module 664, and a feedback receiving sub-module 665. Functions of the above-mentioned sub-modules 661-665 are detailed in the following description.

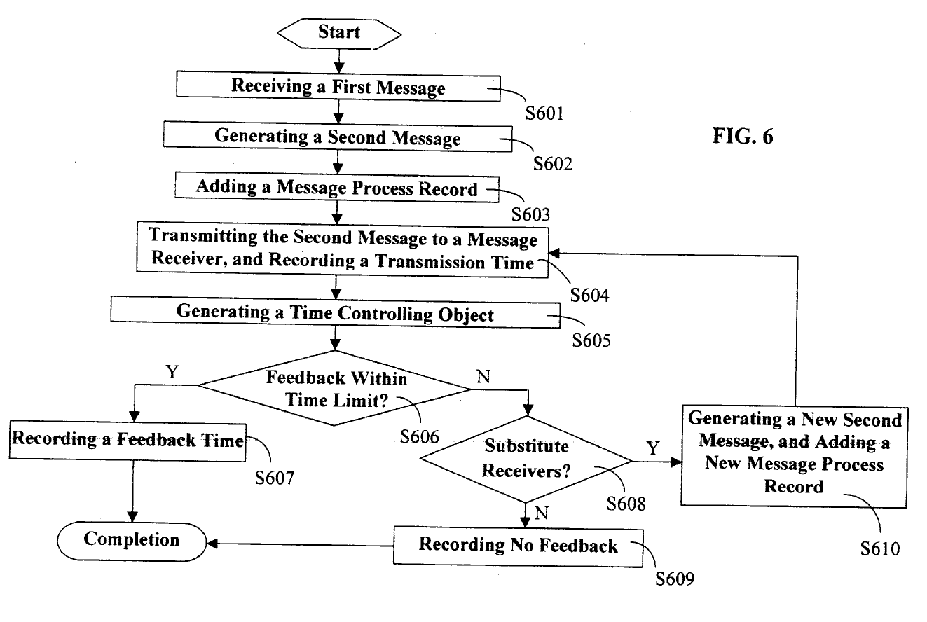

FIG. 6 is a flow chart of operation of the multimedia messaging system 6 in the above-described application environment, in accordance with a preferred embodiment of the present invention. At step S601, the message receiving module 62 receives a first message provided by the message providers 2, and stores the first message in the first message cache 64. The first message comprises a message classification symbol, a message receiver, and message content. For example, the message classification symbol may be “Inbound,” the message receiver may be “Tom,” and the message content may be an inbound notice. Then the message processing sub-module 661 of message processing module 66 retrieves the first message from the first message cache 64, and accesses the database 61 to obtain a mode of transmission of the message, “SMS,” and to obtain an address of the message receiver corresponding to the mode of transmission, “XXXXXX.” Based on the above-mentioned information, at step S602, the message processing sub-module 661 generates a second message, and deletes the first message in the first message cache 64. The second message comprises a serial number, the message classification symbol, the message receiver, the address, and the message content. The second message is stored in the second message cache 67. At step S603, the process recording sub-module 664 of the message processing module 66 adds a message process record in the process recording sheet 615, thereby recording a processing serial number, the message classification symbol, the message receiver, substitutes of the message receiver, and processing steps. At step S604, the message sending module 68 accesses the second message cache 67 to obtain the second message, and transmits the second message to the message receiver 4. At the same time, the message sending module 68 deletes the second message in the second message cache 67, and records a transmission time in the process recording sheet 615. At step S605, the time controlling sub-module 662 of the message processing module 66 generates a time controlling object, to monitor whether a waiting time for receiving return information from the message receiver 4 exceeds a predetermined time limit of the message. At step S606, the conversion controlling sub-module 663 of the message processing module 66 determines whether the feedback receiving sub-module 665 has received return information within the predetermined time limit. If the feedback receiving sub-module 665 has received return information within the predetermined time limit, at step S607, the process recording sub-module 664 records a feedback time of the message in the “Feedback Time” box of the process recording sheet 615, and records “Y” in the “Feedback?” box. This completes the procedure.

If at step S606 the feedback receiving sub-module 665 has not received return information within the predetermined time limit, at step S608, the conversion controlling sub-module 663 determines whether the message receiver 4 has one or more substitutes, according to the process recording sheet 615. If the message receiver 4 does not have any substitute, at step S609, the process recording sub-module 664 records “N” in the “Feedback?” box of the process recording sheet 615. This completes the procedure.

If at step S606 the message receiver 4 has a substitute, the message processing sub-module 661 treats the substitute as the message receiver, and retrieves an address of the substitute from the contact data sheet 613. At step S610, the message processing sub-module 661 of the message processing module 66 generates a new second message, adds a new message process record, and deletes the “old” time controlling object. Then the procedure returns to step S604, for transmission of the new second message to the substitute of the message receiver 4.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A multimedia messaging system, comprising:
a database for storing relevant basic data, said basic data including message classification data, data on substitutes of message receivers, contact data on message receivers and substitutes thereof, and data on modes of transmission of messages;
a message receiving module for receiving first messages provided by message providers;
a message processing module, comprising:
a message processing sub-module for generating second messages according to respective first messages;
a feedback receiving sub-module for receiving return information on second messages;
a time controlling sub-module for monitoring whether respective waiting times for receiving return information exceed respective predetermined time limits; and
a conversion controlling sub-module for determining whether to transmit second messages to respective substitutes of the message receivers, based on the monitoring by the time controlling sub-module; and
a message sending module for transmitting second messages to respective message receivers or substitutes thereof.

2. The multimedia messaging system as claimed in claim 1, wherein the message processing module further comprises a process recording sub-module for generating message processing records.

3. The multimedia messaging system as claimed in claim 1, further comprising a basic data setting module for setting said basic data.

4. The multimedia messaging system as claimed in claim 1, wherein each of the second messages comprises a respective first message, a message receiver, and a message receiver address.

5. The multimedia messaging system as claimed in claim 1, further comprising a first message cache for storing first messages obtained by the message receiving module.

6. The multimedia messaging system as claimed in claim 1, further comprising a second message cache for storing second messages generated by the message processing module.

7. A multimedia messaging method, comprising the steps of:
(a) receiving various first messages from at least one message provider, and caching the first messages in a first message cache;
(b) generating corresponding second messages based on the first messages and on contact data on at least one message receiver, and caching the second messages in a second message cache;
(c) transmitting the second messages to the at least one message receiver;
(d)determining whether the at least one message receiver sends back return information on the second messages within respective predetermined time limits thereof; and
(e) recording feedback times of the second messages if the at least one message receiver sends back return information on the second messages within the respective predetermined time limits thereof.

8. The multimedia messaging method as claimed in claim 7, wherein step (d) further comprises the step of:
(d1) generating a time controlling object for monitoring whether waiting times for receiving return information from the at least one message receiver exceed respective predetermined time limits of the second messages;
(d2) determining whether the at least one message receiver has a substitute if the at least one message receiver does not send back return information on the second messages within the respective predetermined time limits thereof; and
(d3) recording no feedback, if the at least one message receiver does not have a substitute; or
(d4) generating a new second message based on contact data on the substitute and returning to step (c), if the at least one message receiver has a substitute.

9. The multimedia messaging method as claimed in claim 8, wherein step (d4) further comprises the step of:
adding a new message process record of the new second message in a process recording sheet.

10. The multimedia messaging method as claimed in claim 8, wherein step (d4) further comprises the step of:
deleting the time controlling object.

11. A method of dissipating messages requested by a specific receiver for a media, comprising steps of:
(1) providing a database with information of said specific receiver and sequential agents of said receiver, and a specific field requested by said receiver;
(2) receiving message from different message providers;
(3) filtering and narrowing said messages in said specific field requested by said receiver;
(4) transmitting said filtered messages to said receiver;
(5) ending if a feedback from said receiver within a predetermined period, or transmitting said filter message to a person designated as the first one of said sequential agents of said receiver, who has either same or different communication address relative to the receiver, if no feedback from the receiver within said predetermined period after transmission to said receiver; and
(6) repeating step (5) to others of said sequential agents in order, if no feedback from said agent, until either at least one of said agents responds or all said sequential agents have been tried while without response.
